(19) United States
(12) Patent Application Publication
(10) Pub. No.: US 2006/0176451 A1
(43) Pub. Date: Aug. 10, 2006

(54) Fiber optic rear projection display

(76) Inventors: Huei-Pei Kuo, Cupertino, CA (US); Laurence Hubby, Palo Alto, CA (US); Steven L. Naberhuis, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/052,603

(22) Filed: Feb. 7, 2005

(51) Int. Cl. G03B 21/22

(52) U.S. Cl. 353/74

(57) ABSTRACT

Provided is a fiber optic rear projection display. In a particular embodiment, provided is a plurality of aligned magnifying layers providing a viewing surface. Each magnifying layer includes a plurality of optical fibers. Each fiber has an input end, a midsection and a magnifying output end. The plurality of input ends are aligned. The plurality of magnifying output ends are aligned in substantially contiguous parallel contact. Equal magnification horizontally and vertically can be realized with inclusion of spacers between the layers of the magnifying output ends that are in substantially contiguous parallel contact.

### RELATED APPLICATION

This application is related to U.S. patent application Ser. No.: 10/698829, filed on Oct. 31, 2003 by inventors Huei Pei Kuo, Lawrence M. Hubby, Jr. and Steven L. Naberhuis and entitled “Light Guide Apparatus For Use In Rear Projection Display Environments”, herein incorporated by reference.

### FIELD

This invention relates generally to the field of display devices, and more particularly to screens and related hardware employed in rear projection display devices.

### BACKGROUND

Socially and professionally, most people rely upon video displays in one form or another for at least a portion of their work and/or recreation. With a growing demand for large screens and high definition television (HDTV), cathode ray tubes (CRTs) have largely given way to displays composed of liquid crystal devices (LCDs), light-emitting diodes (LEDs), plasma and front and rear projection systems.

A CRT operates by a scanning electron beam exciting phosphorous-based materials on the back side of a transparent screen, wherein the intensity of each pixel is commonly tied to the intensity of the electron beam. With an LED and plasma display, each pixel is an individual light emitting device capable of generating its own light. With an LCD display, each pixel is a transient light modulating device, individually adjusted to permit light to shine through the pixel.

As neither system utilizes a large tube, LCD, plasma and LED screens may be quite thin and often are lighter than comparable CRT displays. The individual nature of each pixel of a LED, plasma or LCD display introduces the possibility that each pixel may not provide the same quantity of light. One pixel may be brighter or darker than another, a difference that may be quite apparent to the viewer.

The human eye is able to perceive subtle differences in light intensity. This poses a challenge to display manufacturers. If the pixels in a display vary greatly in their light emitting ability, the display will be unacceptable to users.

To avoid such discrepancies in performance, great care is generally applied in the fabrication of LED, plasma and LCD displays in an attempt to insure that the pixels are as uniform and consistently alike as is possible. Frequently, especially with large displays, quality control measures discard a high percentage of displays before they are fully assembled. As such, displays are generally more expensive than they otherwise might be, as the manufacturers must recoup the costs for resources, time and precise tooling for the acceptable displays as well as the unacceptable displays.

Projection systems offer alternatives to LED, plasma and LCD based systems. In many cases, projection display systems are less expensive then comparably sized LED, plasma and LCD display systems. With a front projection system, the image is projected onto a screen from the same side as viewer. If the viewer stands, sits or otherwise blocks the projection the image will be compromised. Front projection systems are therefore often suspended from the ceiling or mounted high upon a rear wall.

In either case the projector remains openly visible and may be considered unsightly. As the screen is designed and intended to reflect the projected light back to the viewer, projection systems are highly susceptible to uncontrolled environmental light - an issue that may limit their applicability in many situations.

Rear projection display systems typically employ a wide angle projection lens, (or multiple lenses) operating in connection with one or more reflective surfaces to direct light received from the a projector through the lens(es) to the back of a screen. The lens and mirror arrangement typically enlarges the image as well.

To accommodate the projector, one or more lens, and reflectors, rear projection displays are typically 18 to 20 inches deep and not suitable for on-wall mounting. A typical rear projection system offering a 55 inch HDTV screen may weigh less than a comparable CRT, but at 200+ pounds it may be difficult and awkward to install and support.

Often rear projection display devices exhibit average or below average picture quality in certain environments. For example, rear projection displays may be difficult to see when viewed from particular angles within a room setting or when light varies within the environment. Aside from a theatrical setting, light output and contrast is a constant issue in most settings and viewing environments.

Despite advances in projectors and enhanced lens elements, the lens & reflector design remains generally unchanged and tends to be a limiting factor in both picture quality and overall display system thickness.

Weight, thickness, durability, cost, aesthetic appearance, and image quality are key considerations for rear projection display systems and display screens. From the manufacturing point of view, cost of production and increased yield are also important.

Hence, there is a need for a fiber optic rear projection display device that overcomes one or more of the drawbacks identified above.

### SUMMARY

This invention provides fiber optic rear projection displays.

In particular, and by way of example only, according to an embodiment of the present invention, this invention provides a fiber optic rear projection display including: a plurality of aligned magnifying layers providing a viewing surface, each magnifying layer including: a plurality of optical fibers, each fiber having an input end, a midsection and an output end, the output end configured to magnify an image presented to the input end; the plurality of input ends aligned as a parallel row square to the input ends; the plurality of output ends aligned in substantially contiguous parallel contact.

### BRIEF DESCRIPTION OF THE DRAWINGS

FIG. 1 shows a schematic diagram of an embodiment of a fiber optic display;

FIG. 2 is a plan view of a magnifying layer incorporated in the display shown in FIG. 1;

FIG. 3 is a partial cross-section view of the output ends of stacked magnifying layers according to an embodiment;

FIG. 4 is a partial cross-section view of an optical fiber as used in the magnifying layer of FIG. 2

FIG. 5 is a partial cross-section view of the stacked input ends and stacked magnifying ends according to an embodiment;

FIG. 6 is a partial plan view of the stacked magnifying layers providing a viewing surface and image input location; and

FIG. 7 shows a schematic diagram of an embodiment of a fiber optic rear projection display complete with a case.

### DETAILED DESCRIPTION

Before proceeding with the detailed description, it is to be appreciated that the present teaching is by way of example, not by limitation. The concepts herein are not limited to use or application with a specific fiber optic rear projection display system. Thus, although the instrumentalities described herein are for the convenience of explanation, shown and described with respect to exemplary embodiments, it will be appreciated that the principals herein may be equally applied in other types of fiber optic rear projection display systems.

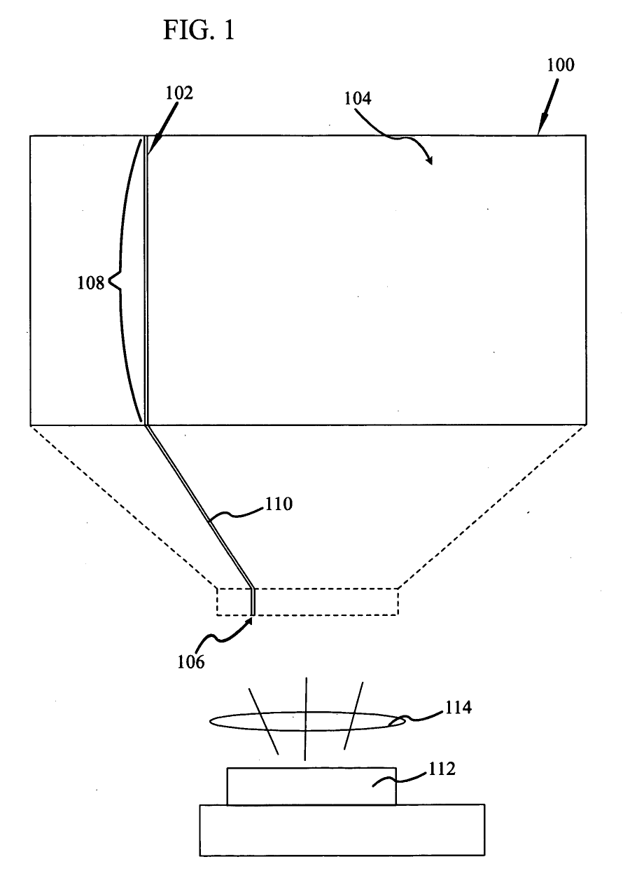

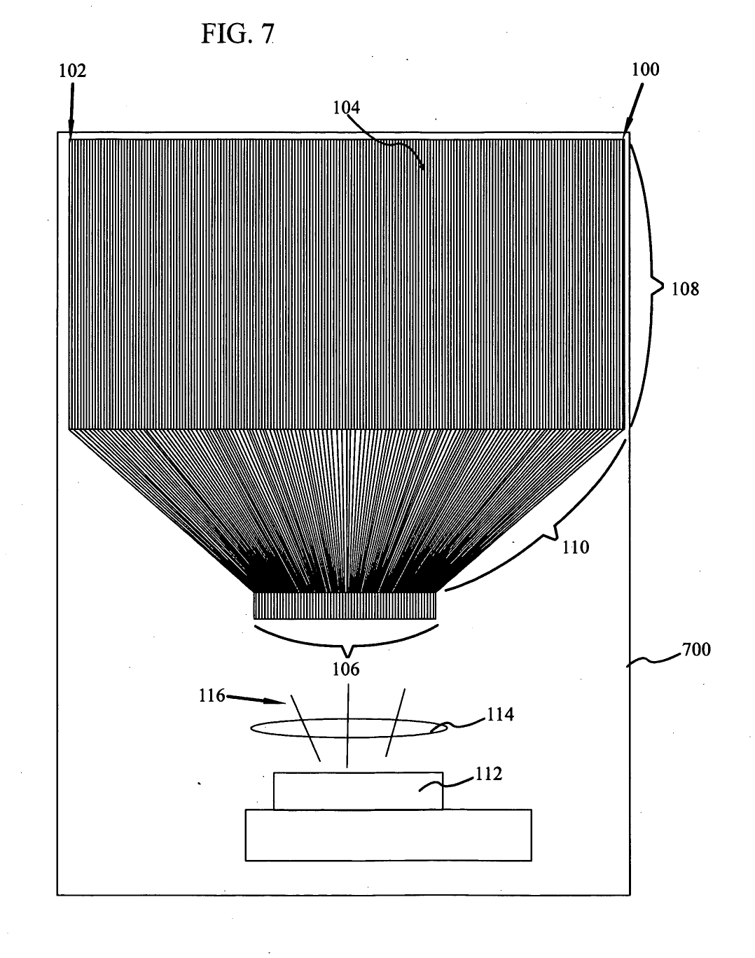

Referring now to the drawings, and more specifically to FIG. 1, there is shown a portion of a fiber optic rear projection display (herein after “FORPD”) 100. In at least one embodiment the FORPD 100 has a plurality of aligned magnifying layers 102 providing a viewing surface 104. Specifically, the magnifying layers 102 each provide an input location 106, a magnifying output location 108, and a midsection 110. Whereas FIG. 1 illustrates a single magnifying layer 102 for ease of discussion and the introduction of components, FIG. 7 may be referred to as a more complete rendering of FORPD 100 with a plurality of magnifying layers 102.

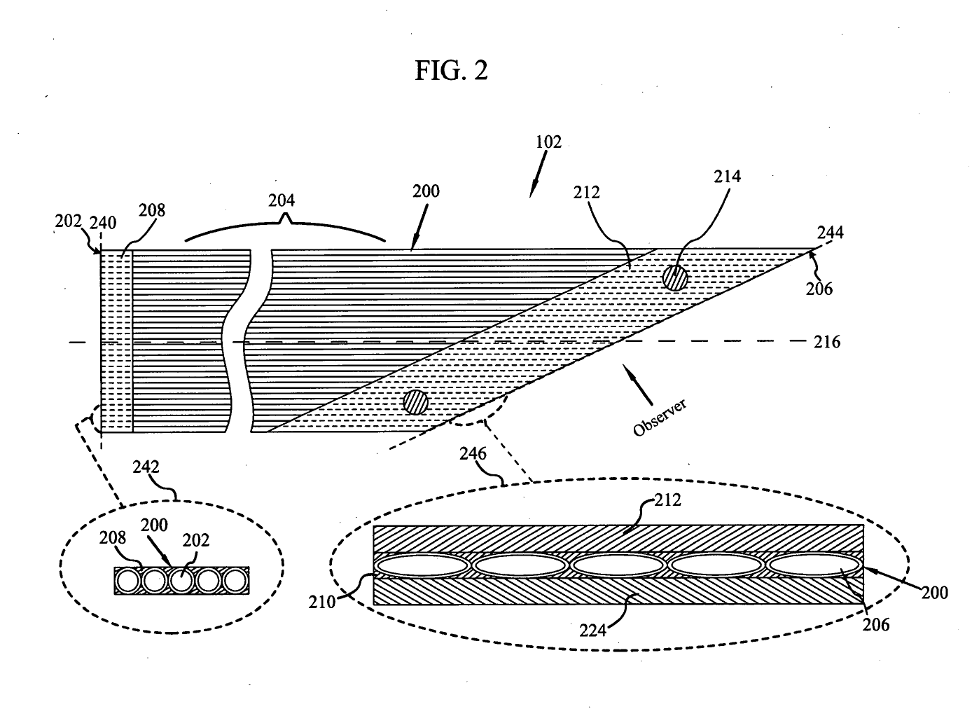

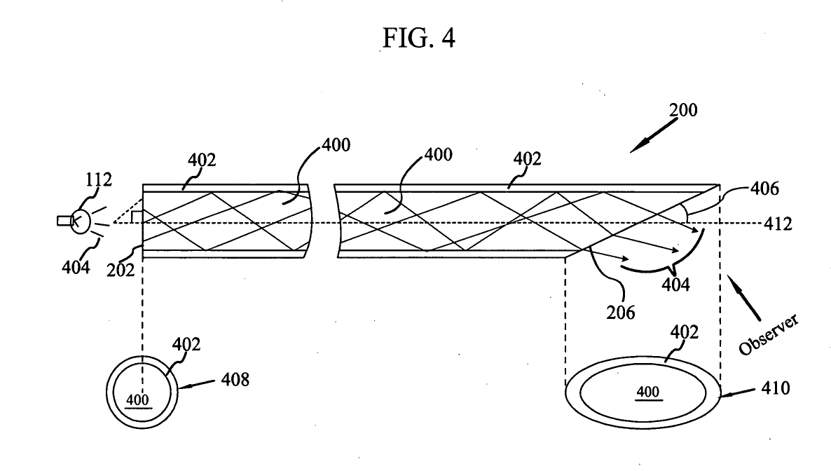

As shown in FIG. 2, each magnifying layer 102 has plurality of optical fibers 200. It is understood and appreciated that optical fibers 200 as used herein are cladded optical fibers. Each optical fiber 200 consists of a core that is substantially optically clear and a circumferential cladding, further discussed below with respect to FIG. 4. The core has an index of refraction, n1, and the clad has an index of refraction n2, wherein n1>n2.

Each optical fiber has an input end 202, a midsection 204, and a magnifying output end 206. In at least one embodiment, the midsection 204 is a flexible midsection. The magnifying output end 206 is configured to magnify an image presented to the input end 202. The plurality of input ends 202 are aligned. The plurality of magnifying output ends 206 are aligned in substantially contiguous parallel contact.

More specifically, the magnifying output ends 206 are in substantially contiguous intimate contact, without intervening spacers or material separating each individual magnifying output end 206 from its neighbors on either side. In other words, the magnifying output ends 206 lie next to one another and are in actual contact, touching along their outer surfaces at a point.

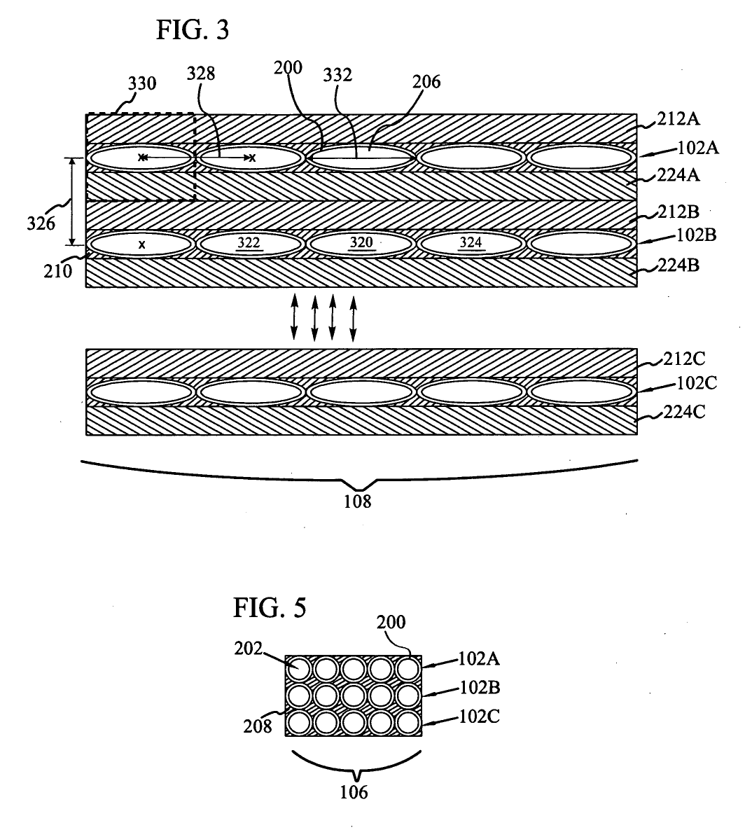

As is further illustrated and described below with reference to FIGS. 3 and 4 (illustrating light guide core 400 and cladding 402) it is understood and appreciated that the light conveying cores of each optical fiber are not in contact, rather it is the cladded outer surfaces that are in contact. Moreover, over the course of each entire length, the core of one optical fiber 200 will not contact the core of another optical fiber 200.

FIG. 2 illustratively shows thirty-three optical fibers 200 for ease of discussion and conceptualization. Embodiments may employ more or fewer optical fibers 200. Preferably, optical fibers 200 are always in substantially contiguous parallel contact particularly in the aligned input ends 202 and the aligned output ends 206; however, due to limitations in manufacturing, instances may arise where a small amount of space might exit between one or more optical fibers 200. However the majority of optical fibers 200 are intended to be in substantially contiguous parallel contact. The midsections 204 of the optical fibers 200 may not necessarily be in contiguous contact.

In at least one embodiment, glue 208 bonds the aligned input ends 202 to define a portion of dotted line 240. The glue 208 bonding the input ends 202 may be more easily perceived in the enlarged end view bounded by dotted line 242. It is this portion of line 240 that serves as the input location 106 of the magnifying layer 102 shown in FIG. 1.

Similarly, in at least one embodiment, glue 210 bonds the aligned magnifying output ends 206 into a uniform line defining a portion of dashed line 244. The glue 210 bonding the magnifying output ends 206 may be more easily perceived in the enlarged end view bounded by dotted line 246. In at least one embodiment, the glue 208 bonding the aligned input ends 202 is the same type of glue bonding the aligned magnifying output ends 206.

As shown in FIG. 2, in at least one embodiment, the plurality of optical fibers 200 are aligned to provide an input end 202 that is substantially transverse (in at least one embodiment, perpendicular) to the relative longitudinal axis 216 of magnifying layer 102. In contrast, magnifying output end 206 is usually not perpendicular to the longitudinal axis 216. More specifically, the dotted line 242 defined by magnifying output end 206 is angled relative to the longitudinal axis 216.

FIG. 1 does not illustrate the individual optical fiber elements of each magnifying layer 102, however, the uniform line of magnifying output ends 206 corresponds to the magnifying output location 108 shown in FIG. 1. The midsections 204 collectively are represented as midsection 110, and as shown in FIG. 1, permit separate orientation/positioning of the input location 106 from the aligned magnifying output location 108. Where, as in at least one embodiment the midsections 204 of optical fibers 200 are flexible, the midsections 110 of each magnifying layer 102 are also flexible. Such flexibility is preferred in at least one embodiment so as to facilitate, for example, fabrication.

As shown in FIG. 1, each magnifying layer 102 provides one vertical slice of the FORPD 100. As shown in FIG. 1, in at least one embodiment each magnifying layer 102 is a continuous vertical slice across the viewing surface 104 of the display. In an alternative configuration (not shown), each magnifying layer 102 is a continuous horizontal slice across the viewing surface 104 of the display. An image is projected upon input location 106. Such an image may be provided in at least one embodiment by an image source 112 proximate to the input location 106. A lens 114 may optically couple the at least one image source 112 to the input location 106, or the lens 114 may be an integral part of the image source 112.

Image source 112 may be any device capable of providing a visual image, such as, for example, a projector. Image source 112 is not limited simply to this example, and may also include combinations of devices. For example, multiple light/image sources (such as red, green, and blue illuminated liquid crystal light valves) may be used as well. As is further explained below the image focused upon the input location 106 is expanded to appear upon the viewing surface 104.

Returning to FIG. 2, as stated above, glue 210 may be applied to bond the magnifying output ends 206 together as a portion of line 244. In at least one embodiment, spacers are disposed between each magnifying layer 102. FIG. 2 illustrates a top spacer 212 applied over the aligned magnifying output ends 206. A similar bottom spacer 224, shown in enlarged end view bounded by dotted line 246) may also be joined to the aligned magnifying output ends 206. In at least one embodiment, the spacers 212, 224 have a uniform width such that the stacked magnifying layers 102 provide a substantially flat output surface.

FIG. 3 provides a cross-sectional view of three magnifying layers (102A, 102B, 102C) along dashed line 244 imposed upon magnifying layer 102 in FIG. 2. Top spacer 212 is bonded to the magnifying output ends 206 with glue 210.

The substantially contiguous parallel contact between the magnifying output ends 206 of optical fibers 200 may also be more fully appreciated. As shown, optical fiber 320 is in intimate contact with optical fiber 322, lying to the left, and optical fiber 324, lying to the right.

FIG. 4 is an enlarged cross-section of a single optical fiber 200. Each optical fiber 200 has a longitudinal light guide core 400 and an external circumferential cladding 402. It is of course realized that optical fiber 200 may bend, coil or otherwise contour such that longitudinal centerline 412 is not always a straight line. Optical fiber 200 is shown with core 400 symmetric about longitudinal centerline 412 for ease of discussion and illustration.

In at least one embodiment, the core 400 is formed of a generally optically clear plastic or plastic-type material, including but not limited to plastic such as acrylic, Plexiglas, polycarbonate material, and combinations thereof. In an alternative embodiment, the core 400 is formed of a generally optically clear glass.

In at least one embodiment, each optical fiber 200 is preferably substantially totally internally reflecting such that the light, illustrated as lines 404, received at the input end 202 is substantially delivered to the magnifying output end 206 with minimal loss. Cladding 402 is a material having an index of refraction lower then that of the core 400. Total internal reflection, or TIR, is the reflection of all incident light off a boundary between cladding 402 and core 400. TIR occurs when a light ray is both in a medium of higher index of refraction and approaches a medium of lower index of refraction, and the angle of incidence for the light ray is greater than the “critical angle.”

The critical angle is defined as a the angle of incidence measured with respect to a line normal to the boundary between the two optical media for which light is refracted at an exit angle of 90 degrees—that is, the light propagates along the boundary—when the light impinges on the boundary from the side of the medium of higher index of refraction. For any angle of incidence greater than the critical angle, the light traveling through the medium with a higher index of refraction) will undergo total internal refraction. The value of the critical angle depends upon the combination of materials present on each side of the boundary.

As shown in FIG. 4, input end 202 is substantially perpendicular to longitudinal centerline 412. Magnifying output end 206 is angled relative to longitudinal centerline 412, at angle 406. As such, the horizontal width of input end 202 is not as great as the horizontal width of magnifying output end 206. In the embodiment shown, input end 202 has a substantially circular cross-section 408, while the magnifying output end 206 has a substantially elliptical cross-section 410.

In at least one alternative embodiment, optical fibers 200 may have cross-sections relating to a square, triangle, octagon or other polygon.

With reference now to FIGS. 3 and 5, the magnification provided in at least one embodiment may be further appreciated. FIG. 5 provides an end view of the aligned input ends 202 of three magnifying layers 102A, 102B, 102C. Each layer shown includes five optical fibers 200 in substantially contiguous parallel contact. Further, the cross-section of each optical fiber 200 presents a circular input end 202.

FIG. 3 provides a cross-sectional view of three magnifying layers 102A, 102B, 102C along dashed line 244 in FIG. 2. Each magnifying layer 102A, 102B, 102C is shown with five optical fibers 200 in substantially contiguous parallel contact. In the embodiment shown, top spacers 212 (e.g., top spacer 212A) and bottom spacers 224 (e.g., bottom spacer 224A) provide vertical spacing 326 between the center point “x” of each magnifying output end 206 that is about the same as the center-to-center spacing 328 between adjacent magnifying output ends 206. In addition, in at least one embodiment, the center-to-center spacing 328 is substantially identical to horizontal dimension 332 of each magnifying output end 206. Alternatively, spacers 212 and 224 could form a single spacer that would have substantially the same thickness as the sum of the thicknesses of the top and bottom spacers 212 and 224.

In such a configuration, the top and bottom spacers 212, 224, or the single spacer described previously, provide apparent vertical magnification that is substantially the same as the horizontal magnification provided by each magnifying output end 206. In at least one embodiment, each magnifying output end 206 represents a display pixel 330.

The viewing surface 104 of FORPD 100 is largely composed of display pixels. In at least one embodiment, each display pixel is based upon the magnifying output end 206 of each optical fiber 200. As shown in FIG. 3, a pixel 330 (bounded by dotted line) includes a portion of top spacer 212A and bottom spacer 224A.

FIG. 3 as drawn therefore conceptually represents the apparent magnification provided by the magnifying output ends 206 over the input ends 202. In alternative embodiments, the top and bottom spacers 212, 224 may provide more or less spacing, thus providing more or less apparent vertical magnification as illustrated.

It is further understood and appreciated that the optical fibers 200, top spacers 212, bottom spacers 224, bonding glues 208, 210 and other components are drawn in an exaggerated scale for ease of discussion. In addition, the conventions of vertical and horizontal are used with reference to the orientation of the elements within each figure for ease of discussion.

In at least one embodiment the optical fibers 200 may each be one hundred micrometers in diameter. Where angle 406 (shown in FIG. 4) is five degrees (5°), the horizontal magnification of the magnifying output end 206 over the input end 202 is about a factor of ten. Utilizing top and bottom spacers 212, 224 each with a thickness of four hundred and fifty micrometers gives a vertical magnification of about a factor of ten. Alternatively, single spacers whose thicknesses are nine hundred micrometers could provide spacing between magnifying layers 102 at their output ends 206.

In a typical display screen, visual images are represented by a plurality of individual light points, commonly referred to as pixels. Each pixel may provide the same or different light as its neighbor pixels. As a whole, it is the patterns established by the varying lights provided by the pixels that are perceived by observers as shapes, pictures and images.

Due to the small size of each pixel, and/or the distance from the observer to the display, the independent nature of each pixel is not observed or perceived by the unaided eye. A typical standard TV display provides a vertical to horizontal resolution of 640:480 with about 307,200 pixels. A typical HDTV screen provides a vertical to horizontal resolution of 1920:1080 with about 2,116,800 pixels—a more than six-fold increase over a traditional TV display.

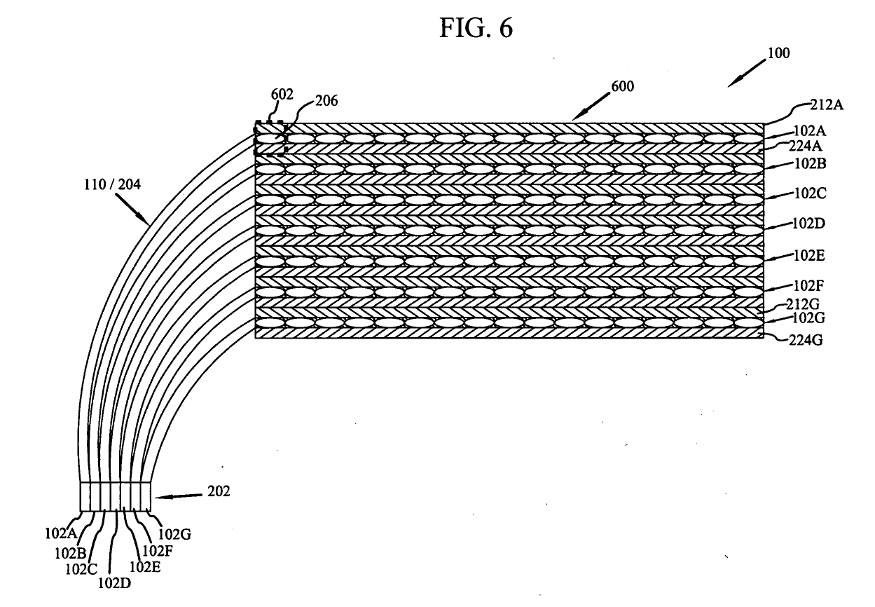

FIG. 6 is an enlarged portion of FORPD 100, showing magnifying layers 102A˜102G, top spacers 212A˜212G and bottom spacers 224A˜224G providing viewing surface 600. The midsections 110 permit aligned input ends 202 to be oriented differently from viewing surface 600, and provide the necessary flexibility for alignment. In at least one embodiment, such separate alignment is advantageous in permitting a large HDTV display, such as a fifty inch display, have a thickness of about four inches. Depending on the cross-sectional dimensions of the optical fibers and the resolution of the screen, light guide screens could be thinner or thicker than four inches. Reasonable thicknesses between one and six inches could be realized for television displays, for example

Various visual image projectors are known in the art. The selection of a particular type of image source 112 is a matter of fabrication preference and intended purpose for the FORPD 100. For a HDTV embodiment an appropriate image source 112 should be selected to render a high definition image upon the collective input location 106 as shown in FIG. 1 and FIG. 7

Where the magnifying layers 102 are vertically continuous across the screen (as shown in FIG. 1), in at least one embodiment there are 1920 aligned magnifying layers 102, each having 1080 optical fibers 200. Where the magnifying layer 102 are horizontally continuous across the screen, in at least one embodiment there are 1080 aligned magnifying layers 102, each having 1920 optical fibers 200. In other embodiments, each light guide layer may include more or fewer optical fibers 200 to provide FORPD 100 with greater or lesser resolution.

By enclosing the FORPD 100, at least one lens 114 and at least one image source 112 within a case 700 as shown in FIG. 7, a low cost, high quality, high resolution HDTV display may be provided. Alternatively, the lens 114 could be integrated with the image source 112. Such a system being largely composed of plastic optical fibers will likely be substantially lighter than comparable LED, LCD, or plasma HDTV displays.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A rear projection display comprising:
a plurality of aligned magnifying layers providing a viewing surface, each magnifying layer including:
a plurality of optical fibers, each fiber having an input end, a midsection and a magnifying output end;
the plurality of input ends aligned;
the plurality of magnifying output ends aligned in substantially contiguous parallel contact.

2. The rear projection display of claim 1, wherein each magnifying layer is horizontally continuous across the display.

3. The rear projection display of claim 1, wherein each magnifying layer is vertically continuous across the display.

4. The rear projection display of claim 1, wherein the midsection permits separate orientation of the aligned input ends from the aligned magnifying output ends.

5. The rear projection display of claim 1, wherein the midsection is flexible..

6. The rear projection display of claim 1, further comprising at least one image source proximate to the aligned input ends.

7. The rear projection display of claim 1, wherein the magnifying output ends are substantially contiguous in parallel contact across a majority of the cross-section of the viewing surface.

8. The rear projection display of claim 1, further comprising 1920 aligned magnifying layers, each having at least 1080 optical fibers, the aligned magnifying layers horizontally stacked.

9. The rear projection display of claim 1, further comprising at least 1080 aligned magnifying layers, each having at least 1920 optical fibers, the aligned magnifying layers vertically stacked.

10. The rear projection display of claim 11, wherein each optical fiber is totally internally reflecting.

11. A rear projection display comprising:
a plurality of aligned magnifying layers providing a viewing surface, each magnifying layer including:
a plurality of optical fibers, each fiber having an input end, a midsection and a magnifying output end;
the plurality of input ends aligned as a parallel row;
the plurality of magnifying output ends aligned in substantially contiguous parallel contact as a cross-section of the viewing surface; and
the midsection permitting separate orientation of the aligned input ends from the output ends.

12. The rear projection display of claim 11, wherein the midsection is flexible.

13. The rear projection display of claim 11, wherein the magnifying output ends are substantially contiguous in parallel contact across a majority of the cross-section of the viewing surface.

14. The rear projection display of claim 11, wherein for each magnifying layer, glue bonds the aligned input ends into a uniform line.

15. The rear projection display of claim 11, wherein for each magnifying layer, glue bonds the aligned magnifying output ends into a uniform line.

16. The rear projection display of claim 15, the line further providing a top surface and a bottom surface, wherein substantially equal spacers are joined to the top and bottom surfaces.

17. The rear projection display of claim 15, the line further providing a top surface, wherein a single spacer is joined to the top surface.

18. The rear projection display of claim 11, further including a top spacer and a bottom spacer joined to the aligned magnifying output ends of each magnifying layer.

19. The rear projection display of claim 11, further including a spacer joined to the aligned magnifying output ends of each magnifying layer.

20. The rear projection display of claim 11, wherein the magnifying output ends are configured to expand an optical image presented to the input ends by about a factor of between five and fifty.

21. The rear projection display of claim 11, wherein each optical fiber further comprises a longitudinal core, the input end being perpendicular to the core, the magnifying output end being angled to the core.

22. The rear projection display of claim 11, wherein each optical fiber is totally internally reflecting.

23. The rear projection display of claim 11, wherein each magnifying output end is a pixel of the display.

24. The rear projection display of claim 11, wherein the optical fibers are plastic.

25. The rear projection display of claim 11, wherein the optical fibers are glass.

26. The rear projection display of claim 11, wherein for each optical fiber the input end is round and the magnifying output end is elliptical.

27. A rear projection display comprising:
a case;
a plurality of aligned magnifying layers providing a viewing surface disposed within the case, each magnifying layer including:
a plurality of optical fibers, each fiber having an input end, a midsection and a magnifying output end;
the plurality of input ends aligned as a parallel row square to the input ends;
the plurality of magnifying output ends aligned in substantially contiguous parallel contact as a cross-section of the viewing surface;
the midsection permitting separate orientation of the aligned input ends from the output ends; and
at least one image source disposed within the case proximate to the aligned input ends.

28. The rear projection display of claim 27, wherein the midsection is flexible.

29. The rear projection display of claim 27, further including at least one spacer joined to the aligned magnifying output ends of each magnifying layer.

30. The rear projection display of claim 27, wherein each optical fiber is totally internally reflecting.
